(19) United States
(12) Patent Application Publication
(10) Pub. No.: US 2021/0042675 A1
(43) Pub. Date: Feb. 11, 2021

(54) DYNAMIC RESOURCES CONVERSION AND PROCESSING SYSTEM

(71) Applicant: BANK OF AMERICA CORPORATION, Charlotte, NC (US)

(72) Inventors: Lee Ann Proud, Ponte Vedra, FL (US); Joseph Benjamin Castinado, North Glenn, CO (US); Martha Sain McClellan, Lancaster, SC (US); Kathleen Hanko Trombley, Oakboro, NC (US)

(73) Assignee: BANK OF AMERICA CORPORATION, Charlotte, NC (US)

(21) Appl. No.: 16/534,815

(22) Filed: Aug. 7, 2019

(51) Int. Cl. G06Q 10/06; G06F 9/54

(52) U.S. Cl. CPC G06Q 10/06312; G06F 9/542

(57) ABSTRACT

A system that provides for selection, at the onset of a resource event, between (i) a first resource event volume of a first resource type (i.e., a resource type associated with the resource-providing entity) and (ii) a second resource event volume of a second type (i.e., a resource type associated with the resource-receiving entity). The first resource event volume used in the selection is determined by applying a conversion rate to the second resource event volume near to or in conjunction with the initiation of the resource event. As a result, resource conversion occurs at the onset of the resource event as opposed to conventional processing which provides for the resource conversion at or near the conclusion of the resource event.

### FIELD OF THE INVENTION

The present invention is generally related to configuring a resource event and, more specifically, providing for selection of resource amounts of different resource types prior to or in conjunction with initiation of the resource event, such that, the conversion rate(s) used to determine the resource amount(s) is defined at the onset of the resource event as opposed to at the conclusion of the resource event.

### BACKGROUND

Typically, when conducting a resource event that requires conversion of the resources from one resource type (i.e., a resource type associated with a first entity that is provided the resources) to a second resource type (i.e., a resource type associated with a second entity that is receiving the resources) the conversion occurs at or near the conclusion of the resource event. Since conventional resource events may occur over a period of days and conversion rates are prone to fluctuation, the first entity is unaware of the exact volume of resources of their associated resource type that are required when the resource event is initiated.

However, since conversion rates tend fluctuate in both positive and negative directions, the first entity may desire certainty in the exact volume of resources of their associated resource type when the resource event is initiated, while in other instances (e.g., when the conversion rate is trending in a positive direction) the first entity may prefer an uncertain scenario in which the conversion rate and, thus, the exact volume of resources are unknown until the resource event is at or near conclusion.

Therefore, a need exists to develop systems, methods, computer program products and the like that provide for more certainty as to the volume of resources required to conduct a resource event that requires conversion from one resource type to another. In addition, a need exists to develop systems, methods, computer program products and the like that allow entities entering into a resource event to select, at the onset of resource event, between application of a known conversion rate applied at the onset of the resource event or an unknown conversion rate applied at or near the conclusion of the resource event.

### BRIEF SUMMARY

The following presents a simplified summary of one or more embodiments of the invention in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing systems, methods, computer program product and/or the like that provide a resource-providing entity to select, while initiating a resource event, between a first resource event volume of a first resource type (i.e., a resource type associated with or preferred by the resource-providing entity) and a second resource event volume of a second type that is different from the first resource type (i.e., a resource type associated with or preferred by the resource-receiving entity). In this regard, the first resource event volume is determined by applying a conversion rate to the second resource event volume near to or in conjunction with the initiation of the resource event. In this regard, the first entity benefits from being able to select between a predetermined resource event volume of the first resource type at the onset of the resource event or, if the first entity believes it to be in their best interest, or an unknown resource event volume of the first resource type, since conversion from the second resource type to the first resource type will occur at a later point in time (i.e., at or near the conclusion of the resource event).

In further embodiments of the invention, in which a resource event requires resource type conversion, the first entity is presented with a first resource volume of a first resource type for an object or the like as the first entity is contemplating adding the object or the like to a resource event. In such embodiments of the invention, the first resource volume presented to the first entity is used as the first resource volume included in an associated resource event, as long as the associated resource event is conducted within a predetermined period of time from the presentation (e.g., predetermined minutes or hours). In this regard, the first entity benefits from knowing the exact resource volume for some, if not all, of the objects or the like comprising the resource event prior to or in conjunction with initiating the resource event.

A system for dynamic resource conversion and resource event processing defines first embodiments of the invention. The system includes a user device having a first memory, at least one first processor in communication with the first memory, and one or more user interfaces in communication with the at least one first processor. The system additionally includes a computing platform having a second memory storing a plurality of first instructions, and at least one second processor in communication with the second memory. The at least one second processor is configured to execute the first instructions to receive an input, from resource-providing entity in control of the user device, that requests performance of a resource event between the resource-providing entity and a resource-receiving entity. The resource event is performed using resources provided from a resource depository in control of the resource-providing entity. The second processor(s) is further configured to execute the first instructions to, in response to receiving the input, determine (i) that that resources in the resource depository are of a first resource type and that the resource-receiving entity is configured to accept resources of a second resource type different from the first resource type and (ii) a first resource event volume required for performing the resource event. The first resource event volume is (i) of the first resource type, and (ii) determined by applying a resource type conversion rate to a second resource event volume of the second resource type required for performing the resource event. Additionally, the second processor(s) is further configured to execute the first instructions to, in response to communicate a signal to the user device that (i) is configured to be outputted by at least one of the one or more user interfaces, and (ii) provides presentation of an option to select between performing the resource event with the first resource event volume or the second resource event volume. In response to the resource-providing entity selecting the first resource event volume, the resource event is initiated, and resources are provided from the resource depository to the resource-receiving entity in a volume equal to the selected first resource event volume.

In specific embodiments of the system, the signal further provides presentation of the resource conversion rate used to determine the first resource event volume.

In other specific embodiments of the system, the user device is a mobile communication device including a mobile application. The mobile application is configured to launch in response to receiving the signal and, in response to the launch, display within the mobile application the option to select between performing the resource event with the first resource event volume or the second resource event volume. In related embodiments of the system, the signal is communicated to the mobile communication device via one of a cellular network communication or a short-range wireless communication.

In further specific embodiments of the system, the resource event is performed via a public communication network and the signal is configured to be displayed on a display of the user device in conjunction with one or more resource event configuration pages. In related embodiments of the system, the user device includes a widget that is configured to launch in response to receiving the signal, and, in response to launch, display within the widget the option to select between performing the resource event with the first resource event volume or the second resource event volume.

In additional specific embodiments of the system, the resource event is performed using a real-time processing network.

In other specific embodiments of the system, the first memory of the user device stores a plurality of second instructions. The at least one first processor is configured to execute the second instructions to receive an input that identifies an object and initiate determination of a first resource volume required for obtaining the object. The first resource volume is (i) of the first resource type, and (ii) determined by applying the resource type conversion rate to a second resource volume of the second resource type required for obtaining the object. The first processor(s) is further configured to execute the second instructions to present, by at least one of the one or more user interfaces, the first resource volume as a volume of resources of the first resource type required for procuring the object as at least part of a subsequent resource event. In related embodiments, in response to initiating the subsequent resource event that includes the object within a predetermined time period from when the first resource volume is presented, communicate a second signal to the user device that (i) is configured to be outputted by at least one of the one or more user interfaces, and (ii) provides presentation of a second option to perform the subsequent resource event using the first resource type in a volume that includes the first resource volume for procuring the object.

A computer-implemented method for dynamic resource conversion and resource event processing defines second embodiments of the invention. The method is executed by one or more computing processor devices. The method includes receiving an input, from a resource-providing entity in control of a user device, that requests performance of a resource event between the resource-providing entity and a resource-receiving entity. The resource event is performed using resources provided from a resource depository in control of the resource-providing entity. The method additionally includes, in response to receiving the input, determining (i) that that resources in the resource depository are of a first resource type and that the resource-receiving entity is configured to accept resources of a second resource type different from the first resource type, and (ii) a first resource event volume required for performing the resource event, wherein the first resource event volume is (a) of the first resource type, and (b) determined by applying a resource type conversion rate to a second resource event volume of the second resource type required for performing the resource event. Additionally, the method includes communicating a signal to the user device that (i) is configured to be outputted by at least one of the one or more user interfaces, and (ii) provides presentation of an option to select between performing the resource event with the first resource event volume or the second resource event volume. Further, the method includes, in response to the resource-providing entity selecting the first resource event volume, the resource event is initiated, and resources are provided from the resource depository to the resource-receiving entity in a volume equal to the selected first resource event volume.

In specific embodiments of the method, communicating the signal further comprises communicating the signal to the user device that provides presentation of the resource conversion rate used to determine the first resource event volume.

In other specific embodiments of the method, the user device is a mobile communication device including a mobile application, such that, in response to the mobile communication device receiving the signal, the mobile application launches and displays within the mobile application the option to select between performing the resource event with the first resource event volume or the second resource event volume. In related embodiments of the method, communicating the signal further comprises communicating the signal to the mobile communication device via one of a cellular network communication or a short-range wireless communication.

In still further specific embodiments of the method, the resource event is performed via a public communication network and the signal is configured to be displayed on a display of the user device in conjunction with one or more resource event configuration pages. In related embodiments of the method, the user device includes a widget, such that, in response to the mobile communication device receiving the signal, the widget launches and displays within the widget the option to select between performing the resource event with the first resource event volume or the second resource event volume.

A computer program product including a non-transitory computer-readable medium defines third embodiments of the invention. The computer-readable medium includes a first set of codes for causing a computer to receive an input, from a resource-providing entity of a user device, that requests performance of a resource event between the resource-providing entity and a resource-receiving entity. The resource event is performed using resources provided from a resource depository in control of the resource-providing entity. The computer-readable medium includes a second set of codes for causing a computer to, in response to receiving the input, determine that that resources in the resource depository are of a first resource type and that the resource-receiving entity is configured to accept resources of a second resource type different from the first resource type and a third set of codes for causing a computer to determine a first resource event volume required for performing the resource event, wherein the first resource event volume is (i) of the first resource type, and (ii) determined by applying a resource type conversion rate to a second resource event volume of the second resource type required for performing the resource event. The computer-readable medium additionally includes a fourth set of codes for causing a computer to communicate a signal to the user device that (i) is configured to be outputted by at least one of the one or more user interfaces of the user device, and (ii) provides presentation of an option to select between performing the resource event with the first resource event volume or the second resource event volume, and a fifth set of codes for causing a computer to, in response to the resource-providing entity selecting the first resource event volume, the resource event is initiated, and resources are provided from the resource depository to the resource-receiving entity in a volume equal to the selected first resource event volume.

In specific embodiments of the computer program product the fourth set of codes is further configured to cause the computer to communicate the signal to the user device that provides presentation of the resource conversion rate used to determine the first resource event volume.

In other specific embodiments of the computer program product the user device is a mobile communication device including a mobile application, wherein in response to the mobile communication device receiving the signal, the mobile application launches and displays within the mobile application the option to select between performing the resource event with the first resource event volume or the second resource event volume. In related embodiments of the computer program product, the fourth set of codes is further configured to communicate the signal to the mobile communication device via one of a cellular network communication or a short-range wireless communication.

In still further specific embodiments of the computer program product the resource event is performed via a public communication network and the signal is configured to be displayed on a display of the user device in conjunction with one or more resource event configuration pages.

Thus, according to embodiments of the invention, which will be discussed in greater detail below, the present invention provides for a resource-providing entity to select, while initiating a resource event, between a first resource event volume of a first resource type (i.e., a resource type associated with or preferred by the resource-providing entity) and a second resource event volume of a second type that is different from the first resource type (i.e., a resource type associated with or preferred by the resource-receiving entity). In this regard, the first resource event volume is determined by applying a conversion rate to the second resource event volume near to or in conjunction with the initiation of the resource event. In this regard, the first entity benefits from being able to select between a predetermined resource event volume of the first resource type at the onset of the resource event or, if the first entity believes it to be in their best interest, or an unknown resource event volume of the first resource type, since conversion from the second resource type to the first resource type will occur at a later point in time (i.e., at or near the conclusion of the resource event).

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the disclosure in general terms, reference will now be made to the accompanying drawings, wherein:

FIG. 1 is a schematic diagram of a system for dynamic resource conversion and processing, in accordance with some embodiments of the present disclosure;

FIGS. 2 and 3 are a block diagrams of a computing platform including instructions configured for dynamic resource conversion and processing, in accordance with some embodiments of the present disclosure;

FIG. 4 is a flow diagram of a method for dynamic resource conversion and processing, in accordance with embodiment of the present invention;

FIG. 5 is schematic diagram of a user device configured for presentation of the resource conversation options, in accordance with some embodiments of the present disclosure; and

FIG. 6 is schematic diagram of a system for presentation of the resource conversation options, in accordance with some embodiments of the present disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of skill in the art in view of this disclosure, the present invention may be embodied as a system, a method, a computer program product or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer-readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as JAVA, PERL, SMALLTALK, C++, PYTHON or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or systems. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus to cause a series of operational events to be performed on the computer or other programmable apparatus to produce a computer implemented process such that the instructions, which execute on the computer or other programmable apparatus, provide events for implementing the functions/acts specified in the flowchart and/or block diagram block or blocks. Alternatively, computer program implemented events or acts may be combined with operator or human implemented events or acts in order to carry out an embodiment of the invention.

As the phrase is used herein, a processor may be “configured to” perform or “configured for” performing a certain function in a variety of ways, including, for example, by having one or more general-purpose circuits perform the function by executing particular computer-executable program code embodied in computer-readable medium, and/or by having one or more application-specific circuits perform the function.

Thus, according to embodiments of the invention, which will be described in more detail below, systems, methods and computer program products are disclosed that provide for a resource-providing entity to select, while initiating a resource event, between (i) a first resource event volume of a first resource type (i.e., a resource type associated with or preferred by the resource-providing entity) and (ii) a second resource event volume of a second type that is different from the first resource type (i.e., a resource type associated with or preferred by the resource-receiving entity). According to embodiments of the invention, the first resource event volume is determined by applying a conversion rate to the second resource event volume near to or in conjunction with the initiation of the resource event. In addition, the first resource event volume may include a network exchange volume and processing volume in the first resource type. In this regard, the conversion rate can be locked-in or otherwise guaranteed at the onset of the resource event. As a result of the present invention the first entity benefits from being able to select between a predetermined resource event volume of the first resource type at the onset of the resource event or, if the first entity believes it to be in their best interest, or an unknown resource event volume of the first resource type, since conversion from the second resource type to the first resource type will occur at a later point in time (i.e., at or near the conclusion of the resource event).

In specific embodiments of the invention, in which the resource event is a financial transaction, the user/payor selects, while an initiating a transaction (e.g., at a point-of-sale terminal or at a check-out page within an online transaction) between (i) first payment amount of a first currency type associated with the user/payee (e.g., the currency type in which the user/payor's accounts are held) and (ii) a second payment amount of second currency type associated with the other party to the transaction (e.g., the currency type that the merchant/payee accepts). The first payment amount is determined, at the onset of the transaction, by applying an exchange rate to the second payment amount. In addition, the first payment amount may include a network exchange rate fee and a card processing fee in the currency type of the user/payor. In this regard, the exchanged rate is deemed fixed or guaranteed at the time that the transaction is initiated as opposed to a later point in time at which the transaction is settled. By providing the user/payor the option to choose between the predetermined first payment amount of their currency type or the second payment amount of the merchant/payee, the present invention takes into the account the fact that exchange rates fluctuate over time and that it may or may not be in the user's/payor's best interest to select a fixed payment amount at the onset of the financial transaction.

In further embodiments of the invention, in which a resource event requires resource type conversion, the first entity is presented with a first resource event volume of a first resource type for an object or the like as the first entity is contemplating adding the object or the like to a resource event. In such embodiments of the invention, the first resource event volume presented to the first entity is used as the first resource volume included in an associated resource event, as long as the associated resource event is conducted within a predetermined period of time from the presentation (e.g., predetermined minutes or hours). In this regard, the first entity benefits from knowing the exact resource event volume for some, if not all, of the objects or the like comprising the resource event prior to or in conjunction with initiating the resource event.

In specific embodiments of the invention, in which the resource event is a financial transaction requiring currency exchange, the user/payor may browse or otherwise contemplate adding an item or service to the financial transaction. This may be down in physical environment (e.g., within a brick and mortar facility) or in an online environment. Once the contemplated item or good is identified, the user/payor is presented with the payment amount for the object or good in their respective currency type. The payment amount that is presented to the user/payor will serve as the payment amount for the item/good, as long as the user/payee subsequently selects to conduct the related financial transaction using a payment amount in their respective currency type and, in some embodiments, as long as the financial transaction occurs within a predetermined period of time.

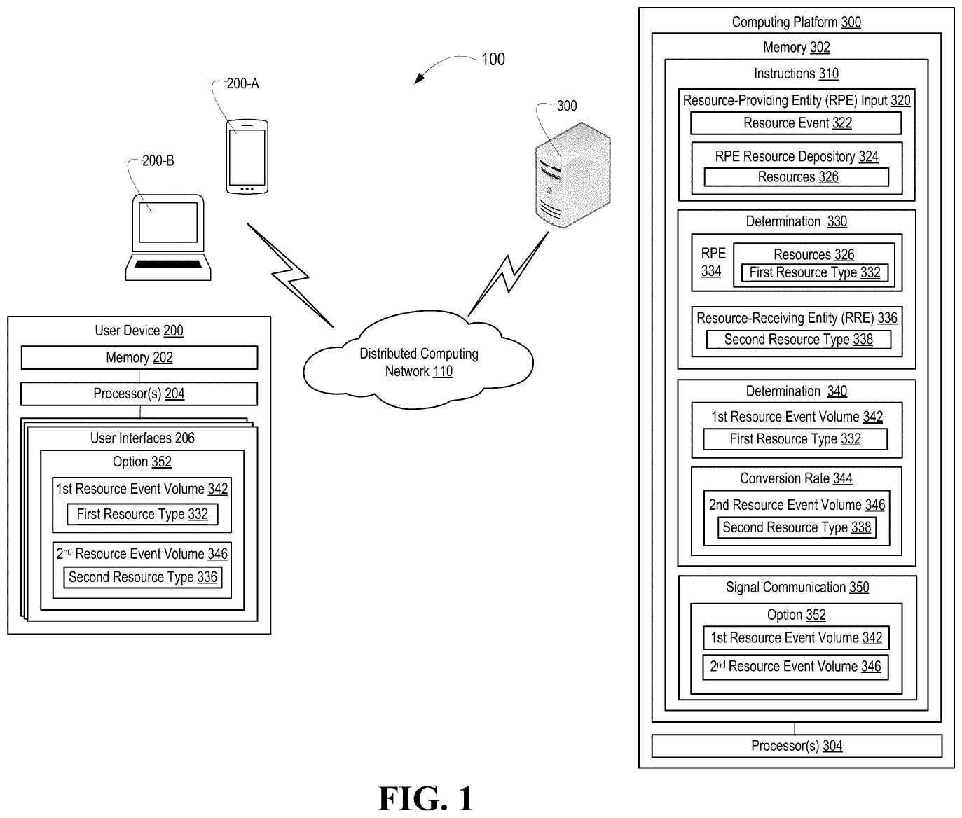

Turning now to the figures, FIG. 1 illustrates a system 100 for dynamic resource conversion and processing, in accordance with embodiments of the present invention. The system 100 is implemented in a distributed computing network 110, which may include the Internet, one or more intranets, short-range wireless networks or any combination thereof. The system additionally includes a user device 200 that may comprise a mobile communication device 200-A and/or another networked device, such as a personal computer 200-B, laptop or the like. The user device includes a memory 202, one or more processors 204 in communication with the memory 202, and one or more user interfaces 206 in communication with the processor that are configured to output data to the user. In this regard, the user interfaces 206 may comprises a display, a microphone or the like.

The system additionally includes a computing platform 300 which may comprise one or more servers (as shown in FIG. 1), or one or more other computing devices, such as a point-of-sale (POS) terminal. In other embodiments of the invention, some, or all, of the functionality provided by the computing platform 300 may be included in user device 200. The computing platform includes a memory 302 and one or more processors 304 in communication with the memory 302. The memory 302 stores a plurality of instructions 310 which are executable by the one or more processors 304. The instructions 310 are configured to receive an input 320 from a resource-providing entity 334 in control of the user device 200, that requests performance of a resource event 322 between the resource-providing entity 334 and a resource-receiving entity 336. The resource event 322 is to be performed using resources 326 from a resource depository 324 in control of the resource-providing entity 334.

In response to receiving the input 320, the instructions 310 are configured to perform a determination 330 that verifies/determines that the resources 326 in the resource depository 324 are of a first resource type 332 and that the resource-receiving entity 334 is configured to receive resources of a second resource type 338 that is different from the first resource type 332. In response to determination 330, the instructions 310 are further configured to perform a determination 340 that renders/determines a first resource event volume 342 for performing the resource event 322. The first resource event volume 342 is of the first resource type 332 and is determined by applying a resource type conversion rate 344 to a second resource event volume 346 of the second resource type 338 required for performing the resource event 322.

In response to determining the first resource event volume 342, the instructions 310 are configured to generate and communicate a signal 350 to the user device 200 that is configured to present, on one or more of the user interfaces 206, an option 352 for selecting between performing the resource event 322 with the first resource event volume 342 of the first resource type 332 or the second resource event volume 346 of the second resource type 338.

In response to the user selecting the first resource event volume 342, the resource event 322 is performed with resources 326 being provided to the resource-receiving entity 336 from the resource depository 324 in a volume equal to the selected first resource event volume 342.

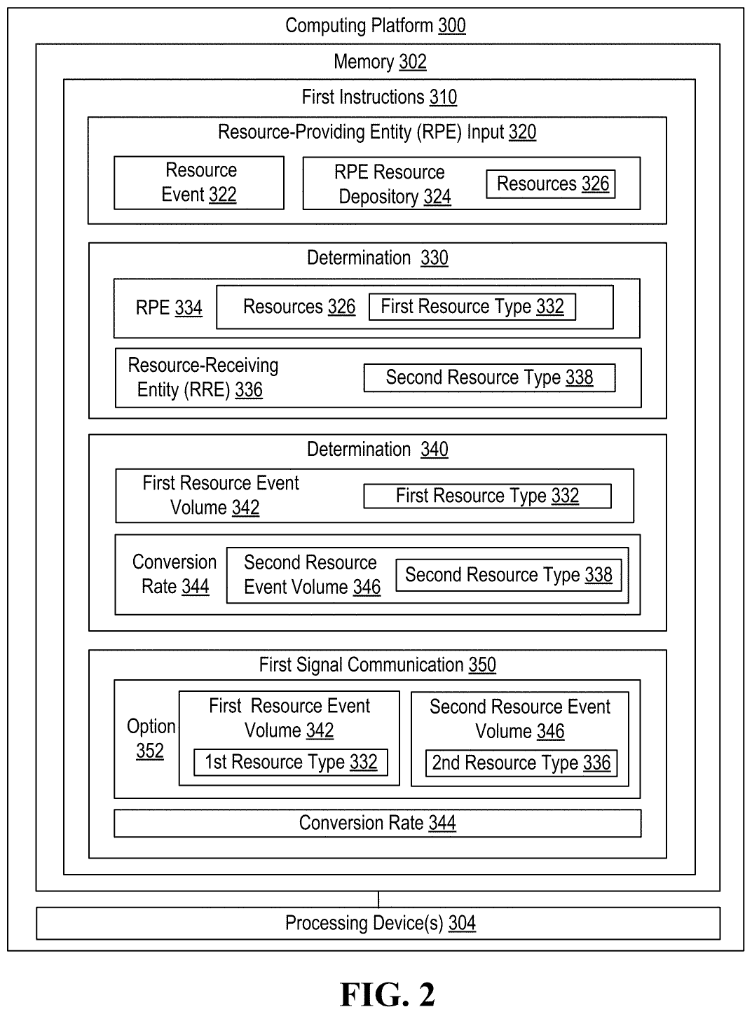

Referring to FIG. 2 a block diagram is depicted of computing platform 300 having first instructions 310 for dynamic resource conversion and processing, in accordance with embodiments of the present invention. Computing platform 300, which may comprise one or more computing devices (e.g., servers, computing devices, POS terminals or the like), is configured to execute instructions 310, such as algorithms, modules, routines, applications and the like. Computing platform 300 includes memory 302, which may comprise volatile and non-volatile memory, such as read-only and/or random-access memory (RAM and ROM), EPROM, EEPROM, flash cards, or any memory common to computing platforms). Moreover, memory 300 may comprise cloud storage, such as provided by a cloud storage service and/or a cloud connection service.

Further, computing platform 300 also includes at least one processing device 304, which may be an application-specific integrated circuit (“ASIC”), or other chipset, logic circuit, or other data processing device. Processing device(s) 304 may execute one or more application programming interface (APIs) (not shown in FIG. 2) that interface with any resident programs, such as instructions 310 or 312 or the like, stored in the memory 302 of the computing platform 300 and any external programs. Processing devices(s) 304 may include various processing subsystems (not shown in FIG. 2) embodied in hardware, firmware, software, and combinations thereof, that enable the functionality of computing platform 300 and the operability of the computing platform 300 on the distributed computing network 110 (shown in FIG. 1). For example, processing subsystems allow for initiating and maintaining communications and exchanging data with other networked devices. For the disclosed aspects, processing subsystems of processing device 304 may include any subsystem used in conjunction with instructions 310 or 312 and related tools, routines, sub-routines, algorithms, sub-algorithms, sub-modules thereof.

Computing platform 300 may additionally include a communications module (not shown in FIG. 2) embodied in hardware, firmware, software, and combinations thereof, that enables electronic communications between the computing platform 300 and other network devices, such as user device 200. Thus, communication module may include the requisite hardware, firmware, software and/or combinations thereof for establishing and maintaining a network communication connection with one or more network devices.

Memory 302 of computing platform 300 stores instructions 310 that are configured to receive an input 320 from a resource-providing entity 334 in control of the user device 200, that requests performance of a resource event 322 between the resource-providing entity 334 and a resource-receiving entity 336. The resource event 322 is to be performed using resources 326 from a resource depository 324 in control of the resource-providing entity 334.

In specific embodiments of the invention, in which the resource event 322 is a financial transaction, the input 320 may be swiping a magnetic card or reading a chip within a smart card to request a financial transaction between the user/payor and a merchant/payee. In such embodiments of the invention, the financial transaction is performed using funds from a payment account in control of the user/payor. Other inputs 320 may also be provided and are within the purview of the present invention, such as, but not limited to, contactless communication of payment credentials from a digital wallet within the user device 200 or the like.

In response to receiving the input 320, the instructions 310 are configured to perform a determination 330 that verifies/determines that the resources 326 in the resource depository 324 are of a first resource type 332 and that the resource-receiving entity 334 is configured to receive resources of a second resource type 338 that is different from the first resource type 332.

In those embodiments of the invention, in which the resource event 332 is a financial transaction, the determination 330 entails determining that the funds in the payment account of a first currency type while the merchant/payee accepts payment in a second currency type. In other words, the user/payee is located in a country other than their country of residency or the country in which their payment accounts are held.

In response to determination 330, the instructions 310 are further configured to perform a determination 340 that renders/determines a first resource event volume 342 for performing the resource event 322. The first resource event volume 342 is of the first resource type 332 and is determined by applying a resource type conversion rate 344 to a second resource event volume 346 of the second resource type 338 required for performing the resource event 322.

In those embodiments of the invention in which the resource event 332 is a financial transaction, the determination 340 involves determining a payment amount for the transaction in the first currency type by applying a foreign exchange (FX) rate to the payment amount of the second currency type. In addition, the payment amount may include a network exchange rate fee and a card processing fee in the currency type of the user/payor. Thus, the user/payee can lock-in or guarantee the FX rate at the time the financial transaction is initiated (e.g., at the merchant while conducting the transaction), as opposed to having the FX rate applied during settlement of the transaction, which may occur one or more days after the transaction is initiated. Moreover, the FX rate that is applied may be a rate offered by the financial institution associated with the payment account, a merchant negotiated rate, or any other rate offered at that moment in time.

In response to determining the first resource event volume 342, the instructions 310 are configured to generate and communicate a signal 350 to the user device 200 that is configured to present, on one or more of the user interfaces 206, an option 352 for selecting between performing the resource event 322 with the first resource event volume 342 of the first resource type 332 or the second resource event volume 346 of the second resource type 338. In addition the signal may be configured to present the conversion rate 344 used to determine the first resource event volume 342.

In those embodiments of the invention in which the resource event 332 is a financial transaction, the signal 350 is configured to be received by the user device 200 and present to the user/payor the option to select between conducting the financial transaction with a payment amount of the user's/payor's preferred currency type (i.e., the currency type associated with the user's/payor's payment account) or the payment amount of the currency type accepted by the merchant/payee. In addition, the signal 350 may be configured to present to the user/payor the exchange rate used to determine the payment amount of the user/payor's preferred currency type. As such, the user/payor can select between (i) a locked-in/guaranteed payment amount or their currency type or, if the user/payor does not prefer the FX rate used to determine the payment amount or believes that the FX rate will move in their favor between now and the time of settlement, (ii) payment amount in the merchant/payor's accepted currency type with the exchange to their currency type occurring at the time of settlement.

In response to the user selecting the first resource event volume 342, the resource event 322 is performed with resources 326 being provided to the resource-receiving entity 336 from the resource depository 324 in a volume equal to the selected first resource event volume 342. In specific embodiments of the invention, the resource event is performed via a real-time processing network that provided for the resources to be transferred to a resource depository in control of the resource-receiving entity in real-time.

In those embodiments of the invention in which the resource event 332 is a financial transaction, in response to the user/payor selecting the payment amount of the user's/payor's preferred currency type (i.e., the currency type associated with the user's/payor's payment account), the financial transaction is performed with funds being provided to the merchant/payee from the user's/payor's payment account in the amount equal to the payment amount that the user/payor selected. Metadata is attached to the payment instructions that insures that the payment is settled in the amount specified using the user's payor's currency type. In specific embodiments of the invention, the financial transaction may be performed by a real-time payment network that provides for the settlement of the transaction (payment to the payor) to occur in real-time to when the transaction was initiated.

Referring to FIG. 3, a block diagram is presented of the computing platform 300 in which second instructions 312 executed to perform optional features, in accordance with optional embodiments of the present invention. Specifically, second instructions 310 are configured to receive an input 360 that identifies an object 360 that a resource-providing entity is contemplating for addition to a resource event. The input 360 may be coded data 364 that when decoded identifies the object 360 or image data 366 that relies on image-recognition techniques to identify the object 360. In other embodiments of the invention the input may comprise other types of data, such as text data, voice data or the like.

In specific embodiments of the invention, in which the resource event is a financial transaction, the input 360 may be received from a user/payor capturing, using an image-capturing device, a barcode or the like affixed to or associated with a product or an image of the product. For example, a user/payor located at a merchant facility/shop may use their mobile communication device to scan barcodes/QR codes or the like associated with a product or take a picture of a product and the mobile communication device may identify the product, or alternatively, the mobile device may communicate the coded or image data to a network entity for product identification. In other instances, in which the user/payor is browsing an online merchant site, the user/payor may place a product in a shopping cart or perform some other predetermined action (e.g., hover over the product for a specified period of time) to indicate that the user/provide is contemplating adding the product to a financial transaction.

In response to receiving the input 320 and identifying the object, the instructions 312 are configured to perform a determination 370 that verifies/determines that the resources 326 used by the resource-providing entity 334 are of a first resource type 332 and that the resource-receiving entity 334 is configured to receive resources of a second resource type 338 that is different from the first resource type 332.

In those embodiments of the invention, in which the resource event 332 is a financial transaction, the determination 370 entails determining that the funds in the payment account are of a first currency type while the merchant/payee accepts payment in a second currency type. In other words, the user/payee is located in a country other than their country of residency or the country in which their payment accounts are held or is browsing a merchant website of a merchant that is located internationally or otherwise accepts a foreign currency

In response to determination 370, the instructions 310 are further configured to perform a determination 380 that renders/determines a first resource volume 382 for the object 362. The first resource volume 382 is of the first resource type 332 and is determined by applying a resource type conversion rate 344 to a second resource volume 384 of the second resource type 336 accepted by the resource-receiving entity 336.

In those embodiments of the invention in which the resource event 332 is a financial transaction, the determination 340 involves determining a payment amount for the product in the first currency type by applying a foreign exchange (FX) rate to the payment amount of the second currency type.

In response to determining the first resource volume 382, the instructions 310 are configured to generate and communicate a signal 390 to the user device 200 that is configured to present, on one or more of the user interfaces 206, the first resource volume 382 of the first resource type 332 and, in some embodiments of the invention, the conversion rate 344 used to determine the first resource volume 344. In specific embodiments of the invention, the first resource volume 382 that is presented on the user device 200 is volume of resources of the first resource type 332 for a subsequent resource event, as long as the resource event occurs within a predetermined time period (e.g., within a predetermined minutes or hours of presenting the first resource volume 382 on the user device or the like)

In those embodiments of the invention in which the resource event 332 is a financial transaction, the signal 350 is configured to be received by the user device 200 and present to the user/payor a payment amount for the product in the user's/payor's preferred currency type (i.e., the currency type associated with the user's/payor's payment account) and, in some embodiments of the invention, the foreign exchange rate used to determine the payment amount of the user/payor's preferred currency type. In such embodiments of the invention, the payment amount presented to the user device may be a locked-in/guaranteed payment amount for the product, as long as the user selects to pay in the preferred currency type and the subsequent financial transaction occurs within a predetermined time period (e.g., predetermined minutes or hours from when the payment amount is presented on the user device).

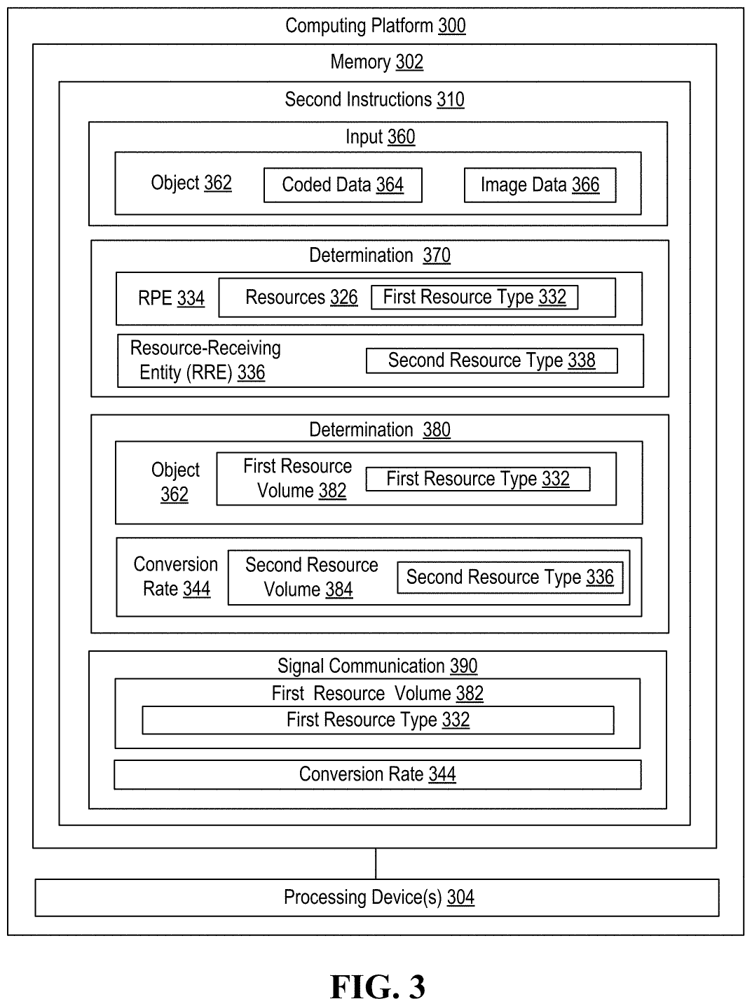

Referring to FIG. 4 a flow diagram of a method 400 for dynamic resource conversion and processing, in accordance with embodiments of the present invention. At Event 410, an input is received, from a resource-providing entity in control of a user device, that requests performance of a resource event between the resource-providing entity and a resource-receiving entity. The resource event is performed using resources from a resource depository in control of the resource-providing entity 334.

In response to receiving the input, at Event 420 a determination is performed that verifies/determines that the resources in the resource depository are of a first resource type and that the resource-receiving entity is configured to receive resources of a second resource type that is different from the first resource type. In response to determining that resource types are different, at Event 430, a second determination is performed to determine/calculate a first resource event volume for performing the resource event. The first resource event volume is of the first resource type and is determined by applying a resource type conversion rate to a second resource event volume of the second resource type required for performing the resource event.

In response to determining the first resource event volume, at Event 440, a signal is generated and communicated to the user device that is configured to present, on one or more of the user interfaces, an option for selecting between performing the resource event with the first resource event volume of the first resource type or the second resource event volume of the second resource type.

In response to the user selecting the first resource event volume, at Event 450, the resource event is performed with resources being provided to the resource-receiving entity from the resource depository in a volume equal to the selected first resource event volume. In specific embodiments of the invention, the resource event is performed via a real-time processing network that provided for the resources to be transferred to a resource depository in control of the resource-receiving entity in real-time.

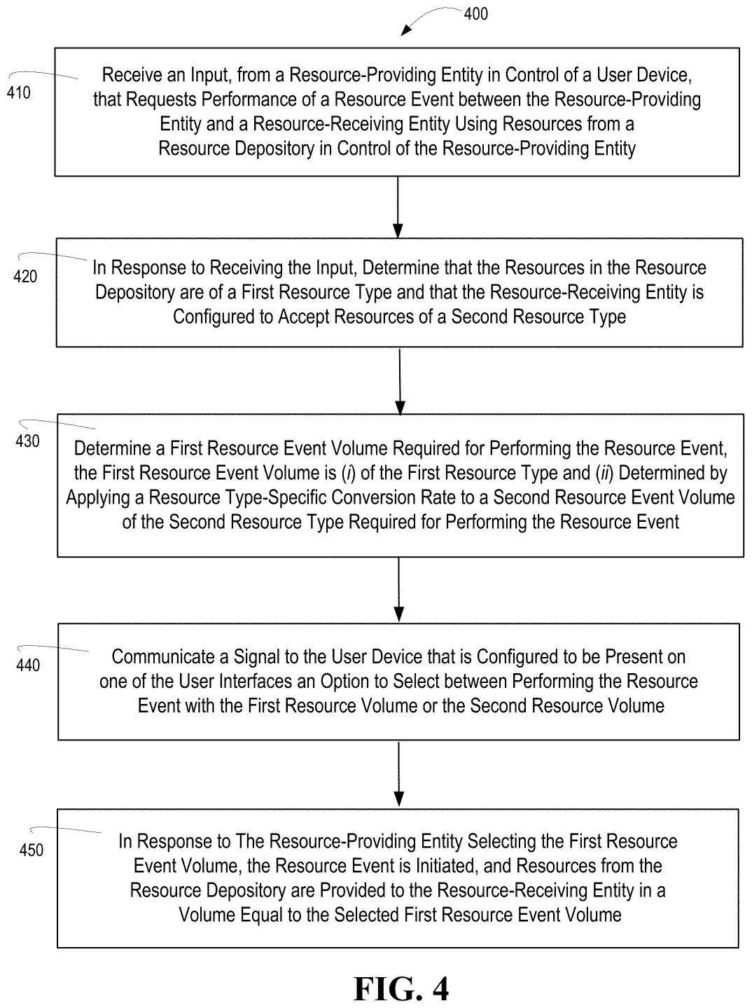

Referring to FIG. 5, a schematic and block diagram is presented of a user device 200-B configured for dynamic resource conversion and processing in accordance with embodiments of the present invention. The user device 200-B may be any computing device, such as PC, laptop computer, tablet computer, mobile communication device or the like that provides network-access to the Internet for conducting electronic commerce transactions. The user device 200-B includes a memory 202 and one or more processors 204 in communication with the memory. The memory stores widget application 206 that is executable by the one or more processors and is configured to 212 to perform or initiate payment amount conversion 208. In this regard, the widget application 206 may interface with the merchant website, such that, once a payment amount is determined for a currency type that is different than the user's preferred payment type (e.g., the merchant website accepts euros and the user prefers dollars), the widget determines or initiates determination (i.e., via the communication network) of the payment amount in the user's preferred currency. The determination occurs by applying a foreign exchange (FX) rate to the payment amount in the currency type accepted by the merchant site. The widget application 208 further includes a payment amount presentation 210 feature that is configured to generate a signal for display of the widget 230, as a pop-up window or the like, within the checkout page 220 of the merchant site. The widget 230 is configured to display options for selecting between the payment amount in the user's preferred currency or the payment amount in the merchant's currency, such that a user may choose between the two different payment options. The widget application 206 additionally includes a user configuration function 212 configured to allow the user to configure parameters associated with the widget application 206, such as, but not limited to, the user's preferred currency type, which types of merchant sites the widget is applicable to, the FX rate to be used, where the widget 230 should be displayed on the display of the user device and the like.

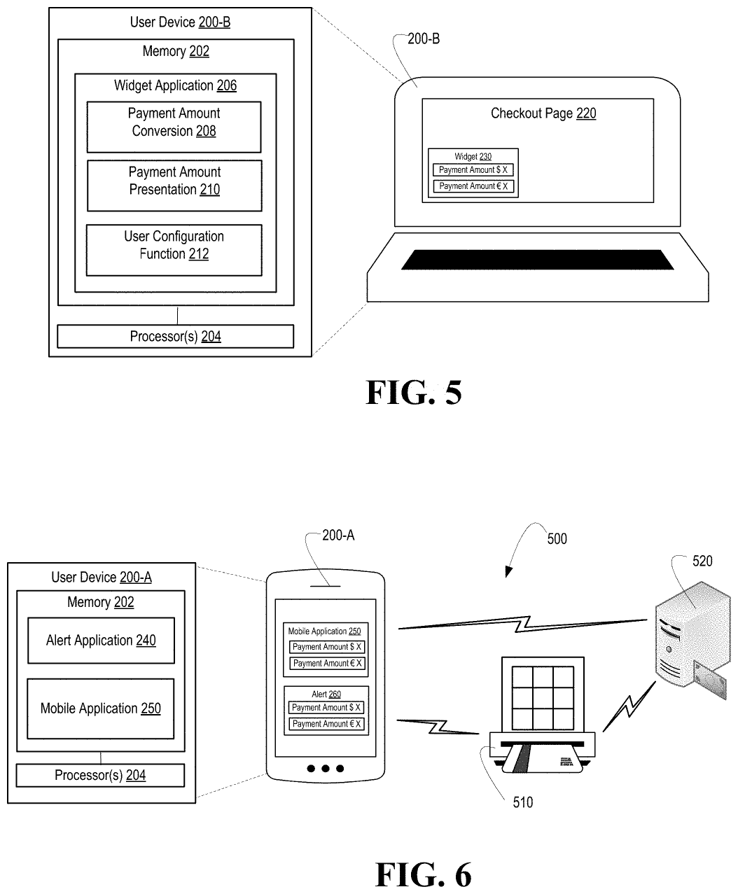

Referring to FIG. 6, a schematic and block diagram is presented of a system 500 for dynamic resource conversion and processing, in accordance with embodiments of the present invention. The system includes a user device 200-A, a POS terminal 510 and a back-end payment processing apparatus 520. The user device 200-A, which may comprise a mobile communication device, such as a smart telephone device or the like, includes a memory 202 and one or more processors 204 in communication with the memory 202. The memory 202 stores alert application 240 and/or mobile application 250 that are executable by the one or more processors and configured to, in response to receiving a signal from the POS terminal 510 or the back-end payment processing apparatus 520, display an alert 260 that includes the payment options or launch the mobile application 250, which displays the payment options. In one embodiment of the invention, the POS terminal 510 may interact directly with the user device 200-A, via a short-range wireless communication network/protocol, such as NFC, Bluetooth® or the like to communicate a signal to the user device that includes the payment options. In other embodiments of the invention, the back-end payment processing apparatus 520 may be configured to communicate the signal to the user device via a cellular network and/or the Internet. The signal may trigger the alert application 240 to display an alert 260 on the user device or, alternatively, the signal may trigger launch of the mobile application, such as financial institution mobile application or a merchant-specific mobile application and, subsequent display of the payment options within the mobile application.

Thus, present embodiments of the invention provide for a resource-providing entity to select, while initiating a resource event, between (i) a first resource event volume of a first resource type (i.e., a resource type associated with or preferred by the resource-providing entity) and (ii) a second resource event volume of a second type (i.e., a resource type associated with or preferred by the resource-receiving entity). Thus, the first resource event volume is determined by applying a conversion rate to the second resource event volume near to or in conjunction with the initiation of the resource event, as opposed to conventional processing in which the conversion rate is applied at or near the conclusion of the resource event. As a result of the invention, the first entity benefits from being able to select between a predetermined resource event volume of the first resource type at the onset of the resource event or, if the first entity believes it to be in their best interest, or an unknown resource event volume of the first resource type, since conversion from the second resource type to the first resource type will occur at a later point in time (i.e., at or near the conclusion of the resource event).

The features, functions, and advantages that have been discussed may be achieved independently in various embodiments of the present invention or may be combined with yet other embodiments, further details of which can be seen with reference to the following description and drawings.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for dynamic resource conversion and resource event processing, the system comprising:
a user device including a first memory, at least one first processor in communication with the first memory, and one or more user interfaces in communication with the at least one first processor;
a computing platform including a second memory storing a plurality of first instructions, and at least one second processor in communication with the second memory, wherein the at least one second processor is configured to execute the first instructions to:
receive an input, from resource-providing entity in control of the user device, that requests performance of a resource event between the resource-providing entity and a resource-receiving entity, wherein the resource event is performed using resources provided from a resource depository in control of the resource-providing entity;
in response to receiving the input, determine that that resources in the resource depository are of a first resource type and that the resource-receiving entity is configured to accept resources of a second resource type different from the first resource type;
determine a first resource event volume required for performing the resource event, wherein the first resource event volume is (i) of the first resource type, and (ii) determined by applying a resource type conversion rate to a second resource event volume of the second resource type required for performing the resource event; and
communicate a signal to the user device that is configured to present on one of the one or more user interfaces an option to select between performing the resource event with the first resource event volume or the second resource event volume,
wherein in response to the resource-providing entity selecting the first resource event volume, the resource event is initiated, and resources are provided from the resource depository to the resource-receiving entity in a volume equal to the selected first resource event volume.

2. The system of claim 1, wherein the signal further provides presentation of the resource conversion rate used to determine the first resource event volume.

3. The system of claim 1, wherein the user device is a mobile communication device including a mobile application, wherein the mobile application is configured to launch in response to receiving the signal and, in response to the launch, display within the mobile application the option to select between performing the resource event with the first resource event volume or the second resource event volume.

4. The system of claim 3, wherein the signal is communicated to the mobile communication device via one of a cellular network communication or a short-range wireless communication.

5. The system of claim 1, wherein the resource event is performed via a public communication network and the signal is configured to be displayed on a display of the user device in conjunction with one or more resource event configuration pages.

6. The system of claim 5, wherein the user device includes a widget, wherein the widget is configured to launch in response to receiving the signal, and, in response to launch, display within the widget the option to select between performing the resource event with the first resource event volume or the second resource event volume.

7. The system of claim 1, wherein the resource event is performed using a real-time processing network.

8. The system of claim 1, wherein the first memory of the user device stores a plurality of second instructions and the at least one first processor is configured to execute the second instructions to:
receive an input that identifies an object;
initiate determination of a first resource volume required for obtaining the object, wherein the first resource volume is (i) of the first resource type, and (ii) determined by applying the resource type conversion rate to a second resource volume of the second resource type required for obtaining the object; and
communicate a second signal to the user device that is configured to present on one of the one or more user interfaces the first resource volume as a volume of resources of the first resource type required for procuring the object as at least part of a subsequent resource event.

9. The system of claim 8, wherein in response to initiating the subsequent resource event that includes the object within a predetermined time period from when the first resource volume is presented, communicate a second signal to the user device that (i) is configured to be outputted by at least one of the one or more user interfaces, and (ii) provides presentation of a second option to perform the subsequent resource event using the first resource type in a volume that includes the first resource volume for procuring the object.

10. A computer-implemented method for dynamic resource conversion and resource event processing, the method is executed by one or more computing processor devices and comprises:
receiving an input, from a resource-providing entity in control of a user device, that requests performance of a resource event between the resource-providing entity and a resource-receiving entity, wherein the resource event is performed using resources provided from a resource depository in control of the resource-providing entity;
in response to receiving the input, determining that that resources in the resource depository are of a first resource type and that the resource-receiving entity is configured to accept resources of a second resource type different from the first resource type;
determining a first resource event volume required for performing the resource event, wherein the first resource event volume is (i) of the first resource type, and (ii) determined by applying a resource type conversion rate to a second resource event volume of the second resource type required for performing the resource event;
communicating a signal to the user device that is configured to present, on one of the one or more user interfaces of the user device, an option to select between performing the resource event with the first resource event volume or the second resource event volume; and
in response to the resource-providing entity selecting the first resource event volume, the resource event is initiated, and resources are provided from the resource depository to the resource-receiving entity in a volume equal to the selected first resource event volume.

11. The computer-implemented method of claim 10, wherein communicating the signal further comprises communicating the signal to the user device that provides presentation of the resource conversion rate used to determine the first resource event volume.

12. The computer-implemented method of claim 10, wherein the user device is a mobile communication device including a mobile application, wherein in response to the mobile communication device receiving the signal, the mobile application launches and displays within the mobile application the option to select between performing the resource event with the first resource event volume or the second resource event volume.

13. The computer-implemented method of claim 12, wherein communicating the signal further comprises communicating the signal to the mobile communication device via one of a cellular network communication or a short-range wireless communication.

14. The computer-implemented method of claim 10, wherein the resource event is performed via a public communication network and the signal is configured to be displayed on a display of the user device in conjunction with one or more resource event configuration pages.

15. The computer-implemented method of claim 14, wherein the user device includes a widget, wherein in response to the mobile communication device receiving the signal, the widget launches and displays within the widget the option to select between performing the resource event with the first resource event volume or the second resource event volume.

16. A computer program product comprising:
a non-transitory computer-readable medium comprising:
a first set of codes for causing a computer to receive an input, from a resource-providing entity of a user device, that requests performance of a resource event between the resource-providing entity and a resource-receiving entity, wherein the resource event is performed using resources provided from a resource depository in control of the resource-providing entity;
a second set of codes for causing a computer to, in response to receiving the input, determine that that resources in the resource depository are of a first resource type and that the resource-receiving entity is configured to accept resources of a second resource type different from the first resource type;
a third set of codes for causing a computer to determine a first resource event volume required for performing the resource event, wherein the first resource event volume is (i) of the first resource type, and (ii) determined by applying a resource type conversion rate to a second resource event volume of the second resource type required for performing the resource event;
a fourth set of codes for causing a computer to communicate a signal to the user device that is configured to present, on one of the one or more user interfaces of the user device, an option to select between performing the resource event with the first resource event volume or the second resource event volume; and
a fifth set of codes for causing a computer to, in response to the resource-providing entity selecting the first resource event volume, the resource event is initiated, and resources are provided from the resource depository to the resource-receiving entity in a volume equal to the selected first resource event volume.

17. The computer program product of claim 16, wherein the fourth set of codes is further configured to cause the computer to communicate the signal to the user device that provides presentation of the resource conversion rate used to determine the first resource event volume.

18. The computer program product of claim 16, wherein the user device is a mobile communication device including a mobile application, wherein in response to the mobile communication device receiving the signal, the mobile application launches and displays within the mobile application the option to select between performing the resource event with the first resource event volume or the second resource event volume.

19. The computer program product of claim 18, wherein the fourth set of codes is further configured to communicate the signal to the mobile communication device via one of a cellular network communication or a short-range wireless communication.

20. The computer program product of claim 16, wherein the resource event is performed via a public communication network and the signal is configured to be displayed on a display of the user device in conjunction with one or more resource event configuration pages.
